(19) United States
(12) Patent Application Publication
(10) Pub. No.: US 2022/0053010 A1
(43) Pub. Date: Feb. 17, 2022

(54) SYSTEM AND METHOD FOR DETERMINING A COMMUNICATION ANOMALY IN AT LEAST ONE NETWORK

(71) Applicant: TWEENZNET LTD., Tel Aviv-Yafo (IL)

(72) Inventors: Eyal ELYASHIV, Ramat Hasharon (IL); Eliezer UPFAL, Providence, RI (US); Aviv YEHEZKEL, Ramat-Gan (IL); Ori OR-MEIR, Ramat Gan (IL)

(73) Assignee: TWEENZNET LTD., Tel Aviv-Yafo (IL)

(21) Appl. No.: 16/992,544

(22) Filed: Aug. 13, 2020

(51) Int. Cl. H04L 29/06; G06N 3/08; G06N 3/04

(52) U.S. Cl. CPC H04L 63/1425; G06N 3/0454; G06N 3/088

(57) ABSTRACT

Systems and methods of detecting communication anomalies in a computer network, including: applying a machine learning (ML) algorithm on sampled network traffic, wherein the ML algorithm is trained with a training dataset comprising vectors to identify an anomaly when the ML algorithm receives a new input vector representing sampled network traffic, normalizing a loss determined by the ML algorithm based on the output of the ML algorithm for the new input vector being different from the output of the ML algorithm for the training dataset, and applying the ML algorithm to analyze the normalized loss to identify an anomaly based on at least one communication pattern in the sampled network traffic, allowing a model trained in one installation to serve as a base model in another installation by normalizing the loss vectors of each installation.

### FIELD OF THE INVENTION

The present invention relates to traffic in computer networks. More particularly, the present invention relates to systems and methods for detecting communication anomalies in at least one computer network.

### BACKGROUND OF THE INVENTION

Computer networks used for data communication can be small household networks such as Wi-Fi networks, or larger networks in the scale of a small-business, city, enterprise, etc. The increase in scale and complexity of these networks poses a significant security challenge when trying to prevent cyber-attacks and/or cyber-threats.

Attacks, threats, and other network anomalies can enter the network through any one of hundreds or even thousands of network devices (e.g., routers, switches, etc.) and can significantly compromise the network security. Adding dedicated network monitoring and detection solutions to each network device is expensive, and can affect the device's performance. Furthermore, monitoring each component separately is not sufficient. Detection of sophisticated cyber-threats requires a global view and analysis of network patterns between the different devices.

Some solutions include analyzing data in the network with a dedicated machine learning (ML) algorithm. However, these algorithms require a complex training process and/or require large processing resources in order to analyze all data for each network device. A common ML approach is to use an anomaly detection algorithm. Such methods can be broadly classified into auto-encoders and hybrid models.

An auto-encoder model is a type of neural network (NN) that is utilized for machine learning in a non-parametric manner The aim of the auto-encoder is to learn a representation (or encoding) for a dataset, for instance for dimensionality reduction, by training the NN to ignore signal noise. Along with the reduction side, a reconstructing side is learned (as a decoder), where the autoencoder tries to generate from the reduced encoding a representation as close as possible to its original input. The auto-encoder approach for anomaly detection utilizes the reconstruction error for making anomaly assessments. The hybrid models combine a deep learning detector with an ML classifier, e.g., learning deep features using an auto-encoder and then feeding the features into a separate anomaly detection method such as a one-class support vector machine (SVM).

### SUMMARY

There is thus provided, in accordance with some embodiments of the invention, a method of detecting communication anomalies in a computer network, the method including: applying, by a processor in communication with the computer network, a machine learning (ML) algorithm on sampled network traffic, wherein the ML algorithm is trained with a training dataset including vectors to identify an anomaly when the ML algorithm receives a new input vector representing sampled network traffic, normalizing, by the processor, a loss determined by the ML algorithm based on the output of the ML algorithm for the new input vector being different from the output of the ML algorithm for the training dataset, and applying, by the processor, the ML algorithm to analyze the normalized loss to identify an anomaly based on at least one communication pattern in the sampled network traffic.

In some embodiments, the ML algorithm is trained for input reconstruction, in which the ML algorithm outputs higher normalized loss for anomaly input. In some embodiments, the ML algorithm includes at least one of: an auto-decoder deep learning network architecture and a generative adversarial network (GAN) architecture. In some embodiments, the processor is configured to classify a type of the identified anomaly.

In some embodiments, a second ML algorithm is trained to classify the identified anomaly of the input vector based on a set of classes in the training dataset. In some embodiments, the second ML algorithm includes at least one of: support vector machine (SVM) ML architecture and deep learning network architecture.

In some embodiments, the ML algorithm is trained with a dataset of descriptive features that characterize the threat type based on the identified anomaly. In some embodiments, the sampled network traffic includes vectors in a plurality of time intervals. In some embodiments, the ML algorithm is configured to allow a model trained in one installation to serve as a base model in another installation by normalizing the loss vectors of each installation.

There is thus provided, in accordance with some embodiments of the invention, a device for detection of communication anomalies in a computer network, the device including: a memory, to store a training dataset, and a processor in communication with the computer network, in which the processor is configured to: apply a machine learning (ML) algorithm on sampled network traffic, in which the ML algorithm is trained with the training dataset including vectors to identify an anomaly, when the ML algorithm receives a new input vector representing sampled network traffic and vectors in the training dataset, normalize a loss determined by the ML algorithm based on the output of the ML algorithm for the new input vector being different from the output of the ML algorithm for the training dataset, and apply the ML algorithm to analyze the normalized loss to identify an anomaly based on at least one communication pattern in the sampled network traffic.

In some embodiments, the ML algorithm is trained for input reconstruction, in which the ML algorithm outputs higher normalized loss for anomaly input. In some embodiments, the ML algorithm includes at least one of: an auto-decoder deep learning network architecture and a generative adversarial network (GAN) architecture.

In some embodiments, the processor is further configured to classify a type of the identified anomaly. In some embodiments, the processor is further configured to train another ML algorithm to classify the identified anomaly of the input vector based on a set of classes in the training dataset. In some embodiments, the ML algorithm includes at least one of: support vector machine (SVM) ML architecture and deep learning network architecture.

In some embodiments, the processor is further configured to train the ML algorithm with a dataset of descriptive features that characterize the threat type based on the identified anomaly. In some embodiments, the sampled network traffic includes vectors in a plurality of time intervals. In some embodiments, the ML algorithm is configured to allow a model trained in one installation to serve as a base model in another installation by normalizing the loss vectors of each installation. In some embodiments, the memory is configured to store a trained model based on the training dataset.

There is thus provided, in accordance with some embodiments of the invention, a method of detecting threats in a computer network, the method including: applying, by a processor, a machine learning (ML) algorithm on a sample of traffic captured from a computer network, normalizing, by the processor, a loss determined by the ML algorithm, in which the ML algorithm is trained with a training dataset to determine loss for traffic samples, and analyzing, by the processor, the normalized loss to identify an anomaly based on at least one communication pattern in the captured traffic.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 shows a block diagram of a device for detecting communication anomalies in a computer network, according to some embodiments of the invention;

FIG. 3 shows a flowchart for an algorithm to detect communication anomalies in the computer network, according to some embodiments of the invention; and

FIG. 4 shows a flowchart for a method of detecting communication anomalies in a computer network, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

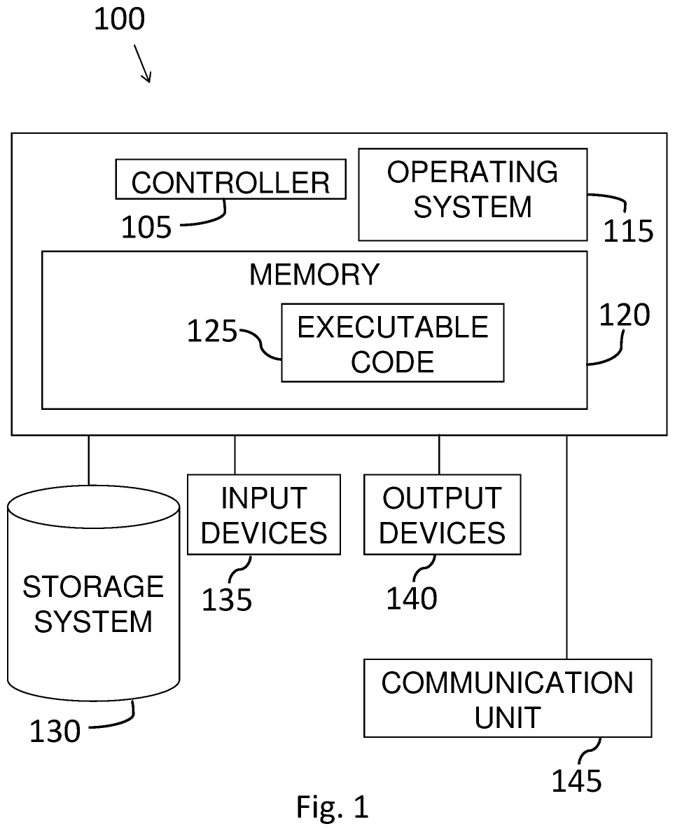

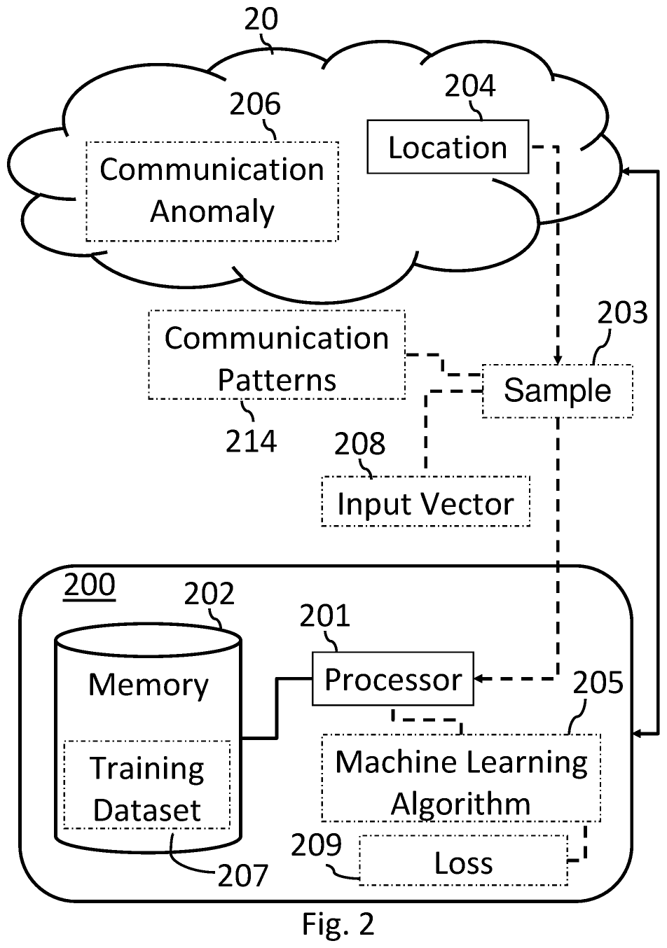

Reference is made to FIG. 1, which is a schematic block diagram of an example computing device 100, according to some embodiments of the invention. Computing device 100 may include a controller or processor 105 (e.g., a central processing unit processor (CPU), a programmable controller or any suitable computing or computational device), memory 120, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a computer communication network, such as, for example, the Internet. The computing device 100 may operate by executing an operating system 115 and/or executable code 125. Controller 105 may be configured to execute program code to perform operations described herein. The system described herein may include one or more computing device 100, for example, to act as the various devices or the components shown in FIG. 2. For example, system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to some embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be, for example, a memory, a disk drive, or a USB flash memory, encoding, including or storing instructions, e.g., computer-executable instructions, which, when executed by a processor or controller, carry out methods disclosed herein. The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device.

Reference is now made to FIG. 2, which shows a block diagram of a device 200 for detecting communication anomalies in a computer network 20, according to some embodiments. In FIG. 2, hardware elements are indicated with a solid line and the direction of arrows may indicate the direction of information flow.

The device 200 may include a processor 201 (e.g., such as controller 105, shown in FIG. 1) in communication with the computer network 20. For example, the device 200 may be a network device coupled to the computer network 20, and configured to analyze communication traffic within the computer network 20. In some embodiments, the processor 201 is configured to sample network traffic of the computer network 20 to analyze a sample 203. For example, the processor 201 may be connected to the network 20 to analyze data packets from a random sample of data traffic of the computer network 20. The sampling may be carried out in at least one location 204 of at least one computer network 20. A location may be, e.g. a network component. For example, the processor 201 may sample traffic at a particular network device of the network 20 such as a router, a switch, a firewall, etc.

In some embodiments, the processor 201 analyzes one or more sampling features or protocols of the sample 203 (e.g., sFlow and NetFlow sampling protocols which may be built-in to network devices), such that there is no need for dedicated hardware modifications and/or software modifications in the computer network 20 in order to detect communication anomalies

According to some embodiments, the processor 201 is configured to apply a machine learning (ML) algorithm 205 on the sampled traffic, in order to detect at least one communication anomaly 206 in the computer network 20. For example, the processor 201 may apply a dedicated deep learning (DL) algorithm to infer the required information from a small and/or sparse traffic sample (e.g., sample 203) to learn network traffic patterns which precede attacks and/or threats in the computer network 20.

In some embodiments, the device 200 further includes a memory 202 (e.g., such as memory 120 or storage system 130, shown in FIG. 1) to store a training dataset 207, in order to train the ML algorithm 205, and/or store information regarding the trained data, etc. The ML algorithm 205 may be trained with the training dataset 207 to detect at least one communication anomaly 206 in the computer network 20 based on a sample of traffic data (e.g., determined as an input vector). For example, the training dataset 207 may include vectors with values corresponding to communication patterns in the computer network 20 that are determined to be associated with at least one communication anomaly 206.

The training dataset 207 may include traffic communication patters (e.g., stored as vectors) associated with attacks and/or threats in the computer network 20. Thus, the ML algorithm 205 may be trained (e.g., using neural networks) with the training dataset 207, using supervised or unsupervised training, to detect at least one communication anomaly 206 based on the input traffic sample. From this training, the ML algorithm 205 may learn desired values for weights and/or bias from labeled examples in the training dataset 207. For example, the ML algorithm 205 may receive as input an input vector, and after applying the ML algorithm 205 the output may be a reconstructed data vector. If the reconstructed data vector corresponds to the training dataset 207, then a communication anomaly may be determined for the input vector.

The ML algorithm 205 may calculate a loss value with a loss function to indicate the difference between the output of the ML algorithm 205 during training for a particular set of weights and the desired output (e.g., detecting an anomaly) from the training dataset 207. Loss functions are used to determine the error (or the loss) between the output of ML algorithms and the given target value. Thus, the loss function expresses how far off the target the computed output is compared to its actual output value. During training of the ML algorithm, the loss function may influence how weights are updated (e.g., in a neural network), such that the larger the loss is, the larger the update. By minimizing the loss, the model's accuracy may be accordingly maximized. To minimize the error in determining the at least one communication anomaly 206 in the computer network 20 by the ML algorithm 205, the loss values may be minimized as well during training of the ML algorithm 205. If the calculated loss is high (e.g., compared to a predefined threshold range) then the error may be considered to be high as well.

The ML algorithm 205 may be trained with the training dataset 207 to determine at least one communication anomaly 206 in the computer network 20, and accordingly calculate the loss value 209 for a new input vector 208 after training has been performed vectors in the training dataset 207. The new input vector 208 may be a data vector that includes values (e.g., indicating communication patterns) corresponding to new input data from the sample 203, e.g. in contrast to existing data in the training dataset 207. For example, the data vector may include values for parameters of the computer network, such as number of packets passing via a predefined port (e.g., port 80), type of protocol, IP address range, etc. The ML algorithm 205 may be trained to determine at least one communication anomaly 206 based on communication patterns in the input vector 208 (e.g., similar to communication patterns in the training dataset 207). For example, the purpose of training the ML algorithm 205 may be to reconstruct the training dataset by minimizing their loss, and output a loss 209 corresponding to minimal error when the input is a new input vector 208 which is similar to vectors in the training dataset 207, such as similar network traffic characteristics or communication patterns indicating at least one communication anomaly 206. In some embodiments, during training, the ML algorithm (e.g., using auto-encoders) may learn to reconstruct the training dataset by minimizing their loss. Then, when seeing a new input vector, if it is similar to the normal data (e.g., similar to the training data points) the output loss may be small, and if it is significantly different the output loss may be high, indicating an “anomaly” compared to the training dataset. In some embodiments, determining the difference between the output vector reconstructed by the ML algorithm 205 and the input vector 208 may include calculating a loss value when comparing communication patterns in the new data vector 208 and the training dataset 207. If the determined loss value is high (e.g., being higher than a predefined baseline or threshold) then the new data vector 208 may be identified as including a communication pattern that may be a threat to the system.

In some embodiments, training of the ML algorithm 205 with the training dataset 207 is based on training an auto-encoder model for each network device (e.g., devices of the computer network 20 that sample traffic as input vectors), utilizing transfer learning by normalizing the auto-encoder loss (as described herein) associated with each device or each computer network. For example, a device of the computer network 20 (that samples traffic) may apply the ML algorithm 205 with the training dataset 207 to determine auto-encoder losses for traffic sampled by that device (as the input vector 208) in the computer network 20. Thus, the device may analyze network traffic (e.g., to determine predefined traffic characteristics such as protocols, ports, etc.) to provide the input of the sampled traffic to the ML algorithm. With transfer learning, knowledge gained (or learned) while solving one problem may be applied to a different problem. Accordingly, a normalized output of the auto-encoder losses of different computer networks 20 may be used as input for a single unified ML algorithm. In some embodiments, instead of an auto-encoder, a generative adversarial network (GAN) may be used to learn the normal inputs and derive reconstruction losses.

Normalizations of the loss vectors may be carried out to provide a non-parametric invariant model for domain adaptation. Thus, a model trained in one implementation may serve as a base model in another implementation. Losses determined by the ML algorithm 205 may be normalized, for instance, based on a baseline of the training dataset 207.

Thus, loss vectors of different network devices that may belong to different networks, e.g., with varying characteristics, properties and behaviors may be translated by the ML algorithm 205 to a unified (or global) language. Accordingly, processing resources may be reduced (e.g., compared to previous methods) since there is no need for dedicated implementation for each network device and/or deployment.

According to some embodiments, the processor 201 applies the ML algorithm 205 to analyze the normalized losses in order to identify an anomaly 206 based on at least one communication pattern 214 in the sampled traffic 203.

The ML algorithm 205 may be trained, for instance by the processor 201, with an auto-encoder architecture to reconstruct the input vector 208. Thus, the ML algorithm 205 may determine the loss (or difference) between the reconstructed output vector and the input vector 208 so as to output higher normalized losses for anomaly input. For example, the ML algorithm 205 may output small normalized losses for normal input and high normalized losses for anomaly input compared to the baseline of the training dataset. In some embodiments, two sets of features are used for ML training through two or more different auto-encoder networks. In some embodiments, at least some features may be included as numbers or values in the input vector 208. The first set of features, F1, may include global (or robust) features dedicated for anomaly detection while having a small false-positive rate. For example, a communication anomaly may include a communication pattern passing via a particular node of the computer network in much grater numbers than with normal communication.

For example, first set of features may include traffic aggregation metrics such as a histogram of the distribution of number of flows and number of new flows, where a flow is a combination of several network fields such as “source IP address” and “destination IP address”. Traffic flows, or sets of packets with a common property, may be defined as several categories in the sample (e.g., flows that are represented with sufficient number of packets in the sample to provide reliable estimate of their frequencies in the total traffic).

The second set of features, F2, may include local (or descriptive) features dedicated for classifying an anomaly and deriving its properties. For example, second set of features may describe hardware and/or software features of the device such as particular ports, protocols, connections, etc. (e.g., related to a particular location of the computer network) that may be classified as potentially compromised if unusually extensive traffic is recorded there.

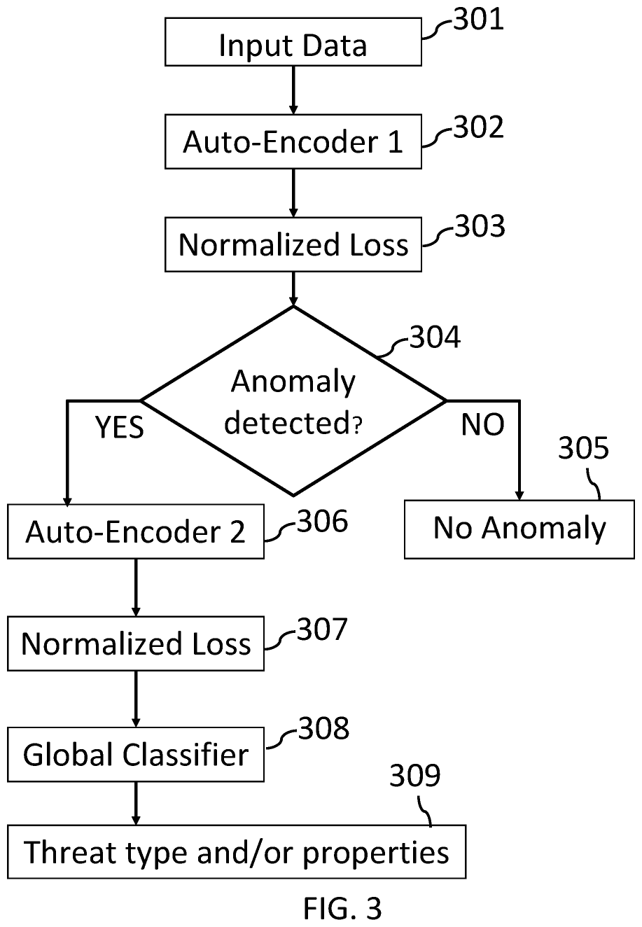

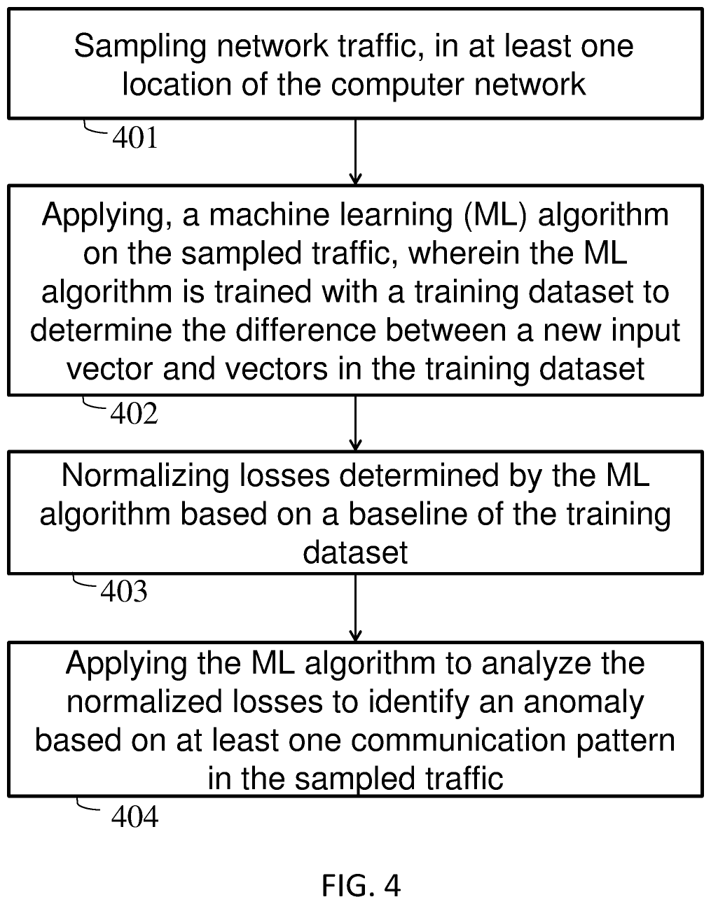

Reference is now made to FIG. 3, a flowchart for an algorithm to detect communication anomalies in the computer network, according to some embodiments. The operations in FIGS. 3 and 4 may be carried out by systems such as shown in FIGS. 1 and 2, but other systems may be used. Communication traffic of the computer network may be collected as traffic samples, as input data 301. Input data 301 may be fed to a first auto-encoder model 302 that is trained to reconstruct the input data 301 (e.g., reconstruct the input vector 208, as shown in FIG. 2) and thus yield higher normalized loss 303 for anomaly input. For example, the first auto-encoder model 302 may output small normalized loss 303 for normal input and high normalized loss 303 for anomaly input.

In some embodiment, a baseline is defined based on a training dataset upon which the first auto-encoder model 302 is trained in order to normalize the loss. Loss normalization may be carried out for example by min-max scaling, norm scaling, etc.

According to some embodiments, a global detector model 304 is trained to detect anomalies based on the output of the first auto-encoder including the normalized loss-vector. For example, the global detector model 304 may be configured to compare the normalized loss-vector from the output of the first auto-encoder with the training dataset to detect an anomaly. In case that the global detector model 304 does not identify an anomaly, the input data 301 may be indicated as “no anomaly” (e.g., normal) 305.

In case that the global detector model 304 identifies an anomaly, the normalized loss 303 data may be fed as input to a second auto-encoder model 306 trained to reconstruct the input data 303 and output a normalized loss 307, this time with a different, more descriptive, set of features, F2, which tracks the spread of recorded traffic over various network fields (e.g., ports, IP addresses, protocols, etc.). The additional features, F2, may be received from the global detector 304, for example, from the network device as another input vector. For example, src_port_i may be the proportion of samples coming from port ‘i’, e.g., src_port_80 may record the proportion of HTTP traffic, and similarly for dst_port_i and protocol_i recording the proportion of samples coming to port ‘i’ and over protocol ‘i’ in respectively. Similarly, common IP connections, e.g., the tuple (src_ip<>dst_ip) may be maintained and the proportion of their samples may be recorded as well. The normalized loss 307 from the second auto-encoder model 306, may in turn be fed to a global classifier 308. The classification model of the global classifier 308 may be used in order to classify the type and/or properties 309 of the detected anomaly such as “Denial of service attack” or “Bot attack”. The anomaly classification may be carried out by inferring the features that have largest deviations from their training state such as network traffic ports and protocols. The classification model may receive as input the normalized losses from the first auto-encoder. For example, the normalized loss vector for F2 features may be [src_port_80=10000, src_port_10=0.5, 1.1.1.1<>2.2.2.2=1, protocol_6=0.2, protocol_17=0.1], then the model may classify the type of the detected anomaly as a “brute force attack over port 80” by observing large deviation of the feature associated with ‘port 80’ from its training state, which may be due to significantly higher number of packets entering the network over port 80 than the normal behavior learnt by the auto-encoder.

In some embodiments, the first and second auto-encoder models may be included in a single ML algorithm. For example, an ML algorithm may initially apply a first auto-encoder model to determine normalized losses, and feeding them to a global detector to determine an anomaly. Once the anomaly is determined, the ML algorithm may apply the second auto-encoder model to determine the second set of normalized losses, this time using the more descriptive features, and feeding them to the global classifier to classify the threat type and properties.

According to some embodiments, the classification model utilizes transfer-learning capabilities in order to keep learning and improving from one installation to another, by using global detector model 304 and/or global classifier 308 which, learns to detect anomalies for different datasets by getting a normalized loss input 303. The loss vector may be normalized according to a baseline which is derived as part of the training stage. This way, the inputs of the global detector model 304 are configured to follow a “similar distribution” and the global detector model 304 learns how to differentiate between “normal” and “anomaly” traffic.

According to some embodiments, prior to the training of the first auto-encoder model 302, a training-data may be collected as {X₁ . . . X_{N}}. Two features-set may be generated from the training-data F1: {F₁¹ . . . F_{1N}¹} and F2: {F₁² . . . F_{1N}²}, where F1 relates to a small number of “general” features that is used for anomaly detection, and where F2 relates to a bigger number of “descriptive” features that is used for threat classification.

In some embodiments, F1 includes an aggregation of the flows that were sampled in a specific window of time, e.g., the histogram of the number of flows that appear at a given time in the sample, how many of them were new with respect to the previous window of time, etc. For example, F1 may be a vector (x_1,y_1, . . . x_i,y_i . . . ), where x_i is the number of flows that had between 2\hat{ } {i−1}+1 to 2\hat{ } i packets in the sample, and y_i is the number in x_i that were new to this time interval (didn't have packets in the previous sample). For example, if the F1 features are [bin_2, bin_2_new], than the vector at timestamp “2020-20-02 10:30:00” may be [bin_2=10, bin_2_news=0] meaning that during this time, 10 flows had between 2\hat{ } {2−1}+1 to 2\hat{ } 2 (e.g., between 3 to 4) packets, and none of them are “new” compared to the previous time interval.

In some embodiments, F2 tracks the spread of recorded traffic over various network fields (ports/IPs/protocols/etc.). For example, src_port_i may be the proportion of samples coming from port ‘i’, e.g., src_port_80 will record the proportion of HTTP traffic, and similarly for dst_port_i and protocol_i recording the proportion of samples coming to port ‘i’ and over protocol ‘i’ in respectively Similarly, common IP connections, e.g., the tuple (src_ip<>dst_ip) may be maintained and the proportion of their samples may be recorded as well. For example, if the F2 features are [src_port_80, src_port_10, 1.1.1.1<>2.2.2.2, protocol_6, protocol_17], than the vector at timestamp “2020-20-02 10:30:00” may be [src_port_80=100, src_port_10=0, 1.1.1.1<>2.2.2.2 =15, protocol_6=10, protocol_17=0] meaning that during this time, 100 packets were from source port 80, no packets were from source port 10, 15 packets were sent and received over the connection 1.1.1.1<>2.2.2.2, 10 packets were from protocol 6 and no packets were from protocol 17.

In some embodiments, the input data may include ‘n’ vectors (e.g., time intervals), ‘n1’ vectors prior to the current sample and ‘n2’ vectors after the current sample in a sliding-window way. This may be for instance instead of using only the current time-window as input. For example, if n_1=10 and n_2=0 then a sliding-window, for example of the last ten time intervals, may be used as input, where each interval has its F1 and F2 features. Then, two auto-encoder networks may be trained. V1 with a small number of features that is used for anomaly detection, and V2 with a bigger number of features, including descriptive features that is used for threat classification. In some embodiments, V2 features are much wider with high variance and thus noisy compared to V1 which is a small set of global features which makes V1 model more robust and less noisy with respect to false-positives. In some embodiments, V2 is being used only in case of a suspected anomaly where more descriptive features are needed to better classify the threat (e.g., suspicious ports, etc.).

For example, an auto-encoder network structure may include 4 hidden layers, each layer with a long-short-term-memory (LSTM) of sizes 16, 8, 4, and 2 hidden states (respectively) which compress the input into a latent-space representation. Then, the decoder may include symmetrical LSTM hidden layers of sizes 4, 8 and 16 which may aim to reconstruct the input from the latent representation. The activation of each layer may be rectified linear unit, defined as ReLU(x)=max(0,x).

Training losses may be calculated using mean-average-error (MAE) or its normalized variation which normalizes the loss to prevent fluctuations due to high input values. In some embodiments, a different number of layers, sizes and architectures may be used, for example a multiplicative factor may be used to increase the hidden state size of each layer while keeping the same ratio between layers. In addition, layer regularizations and dropouts may be added to prevent training' overfitting.

According to some embodiments, after the auto-encoders are trained, the final models may be used on the F1 and F2. For example, the actual input for F1 are {F₁¹ . . . F_{N}¹}, the auto-encoder reconstruction are {\hat{F}₁¹ . . . \hat{F}_{N}¹} and the loss vectors LOSS-V1 are calculated (e.g., |\hat{F}ᵢ¹−\hat{F}ᵢ¹| for every ‘i’). The loss vectors may be normalized to generate a baseline of the training losses BASE-V1. For example, if the actual input is [2] and the auto-encoder reconstruction is [1], then the loss vector may be |2−1|=1. In case that several loss vectors are [1],[10],[0] then a simple min-max baseline is {MAX: 10, MIN: 0} such that a new value of 20 may be normalized to 2. Similarly, LOSS-V2 and BASE-V2 may be generated for F2 features. In such case, a “small loss” may be any value between the MIN and MAX baseline, e.g., [5], while a “high loss” is a value significant higher than MAX (e.g., [10000]) or smaller than MIN (e.g., [−10000]).

Normalization may be done to transform the loss vectors of different network devices that belong to different networks with (possibly significantly) varying characteristics, properties and behaviors to a unified language that is used later for the global detection models.

Datasets including both normal traffic and threat traffic may be collected D₁, . . . D_{L} and split to normal and threat datasets. For each dataset Dᵢ-normal traffic (Dᵢ^{normal}) and threat traffic (Dᵢ^{threat}) which may include normal traffic as well, may be collected. For each dataset Dᵢ, the auto-encoder V1 model and baseline may be generated by training on the normal traffic only (Dᵢ^{normal}). Then, the trained models may be used on the threat traffic (Dᵢ^{threat}) to create their normalized loss vectors of each datapoint with their threat tagging: Vᵢ^{threat}=(ν₁ⁱ,y₁) . . . (v_{N}ⁱ, y_{N}) such that each νⱼⁱ is the normalized loss in time j, and yⱼ is normal or “threat” (with the particular threat type). The Vᵢ^{threat} vectors may be all normalized already so they follow a similar distribution.

In some embodiments, Vᵢ^{threat} are concatenated to create the final dataset of loss-vectors and threats among the various devices, denote it V^{threat} the dataset is used to train another deep-learner model detector (e.g., the global detector 304) that is learning to detect whether the loss-vectors are associated with normal traffic or a threat.

In some embodiments, the global models (detector 304 and/or classifier 308) may include feed-forward neural networks with one hidden-layer, the detector's output layer will be of size 2 denoting “normal” or “threat”, while the classifier's output layer will denote various threat types. Training losses may be calculated using binary cross-entropy for the detector and multiclass cross-entropy for the classifier. In some embodiments, the global models may include SVM algorithms with two classes (e.g., as global detector-“normal” or “threat”) and/or several classes per threat types (e.g., as global classifier).

Tor a new datapoint ‘Z’ 301, the first step may be to create its features F1 and F2,denoted Z1 and Z2 (respectively). Then, the inferring cycle may be as follows: the first auto-encoder V1302 may apply on Z1, the loss may be normalized 303 (e.g., translated into a unified language) and fed into the global detector 304 to predict if the traffic's datapoint is “normal” or “anomaly”. In case of “anomaly” detected, the second auto-encoder, V2 306, may be used on Z2, where the loss is normalized 307 and used in the global classifier to classify the threat type.

In some embodiments, another classifier may be used for deriving the threat details. For example, an SVM classifier can be trained on the threat data VS training-data (normal) in order to yield the features that are mostly different from their “training” state (e.g., highest features importance). In case of a threat detected over multiple continuous timestamps, a majority vote of the various threat type' predictions may be used to improve its accuracy.

Reference is now made to FIG. 4, which shows a flowchart for a method of detecting communication anomalies in a computer network, according to some embodiments.

In Step 401, network traffic may be sampled, by a processor in communication with the computer network. The sampling may be carried out in at least one location of the computer network. In Step 402, an ML algorithm may be applied, by the processor, on the sampled traffic. The ML algorithm may be trained with a training dataset to determine the loss between a new input vector and vectors in the training dataset.

In Step 403, losses determined by the ML algorithm may be normalized, by the processor, based on a baseline of the training dataset. In Step 404, the ML algorithm may be applied, by the processor, to analyze the normalized losses to identify an anomaly based on at least one communication pattern in the sampled traffic.

A system as in FIG. 2 may be or operate a NN which may implement an ML algorithm as described herein; a separate NN may be used for each separate ML module. A NN may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g. CPUs or graphics processing units (GPUs), or a dedicated hardware device may perform the relevant calculations. Neural network systems may learn to perform tasks by considering example input data, generally without being programmed with any task-specific rules, being presented with the correct output for the data, and self-correcting. During learning the NN may execute a forward-backward pass where in the forward pass the NN is presented with an input and produces an output, and in the backward pass (backpropagation) the NN is presented with the correct output, generates an error (e.g., a “loss”), and generates update gradients which are used to alter the weights at the links or edges. A NN may be modelled as an abstract mathematical object, such as a function, executed by a conventional processor. While certain features of the invention have been illustrated and described herein, many modifications, substitutions, changes, and equivalents may occur to those skilled in the art. It is, therefore, to be understood that the appended claims are intended to cover all such modifications and changes as fall within the invention.

Various embodiments have been presented. Each of these embodiments may, of course, include features from other embodiments presented, and embodiments not specifically described may include various features described herein.

1. A method of detecting communication anomalies in a computer network, the method comprising:
applying, by a processor in communication with the computer network, a machine learning (ML) algorithm on sampled network traffic, wherein the ML algorithm is trained with a training dataset comprising vectors to identify an anomaly when the ML algorithm receives a new input vector representing sampled network traffic;
normalizing, by the processor, a loss determined by the ML algorithm based on the output of the ML algorithm for the new input vector being different from the output of the ML algorithm for the training dataset; and
applying, by the processor, the ML algorithm to analyze the normalized loss to identify an anomaly based on at least one communication pattern in the sampled network traffic.

2. The method of claim 1, wherein the ML algorithm is trained for input reconstruction, and wherein the ML algorithm outputs higher normalized loss for anomaly input.

3. The method of claim 1, wherein the ML algorithm comprises at least one of: an auto-decoder deep learning network architecture and a generative adversarial network (GAN) architecture.

4. The method of claim 1, further comprising classifying, by the processor, a type of the identified anomaly.

5. The method of claim 4, further comprising training a second ML algorithm to classify the identified anomaly of the input vector based on a set of classes in the training dataset.

6. The method of claim 5, wherein the second ML algorithm comprises at least one of: support vector ML architecture and deep learning network architecture.

7. The method of claim 4, further comprising training the ML algorithm with a dataset of descriptive features that characterize the threat type based on the identified anomaly.

8. The method of claim 1, wherein the sampled network traffic comprises vectors in a plurality of time intervals.

9. The method of claim 1, wherein the ML algorithm is configured to allow a model trained in one installation to serve as a base model in another installation by normalizing the loss vectors of each installation.

10. A device for detection of communication anomalies in a computer network, the device comprising
a memory, to store a training dataset; and
a processor in communication with the computer network, wherein the processor is configured to:
apply a machine learning (ML) algorithm on sampled network traffic, wherein the ML algorithm is trained with the training dataset comprising vectors to identify an anomaly, when the ML algorithm receives a new input vector representing sampled network traffic and vectors in the training dataset;
normalize a loss determined by the ML algorithm based on the output of the ML algorithm for the new input vector being different from the output of the ML algorithm for the training dataset; and
apply the ML algorithm to analyze the normalized loss to identify an anomaly based on at least one communication pattern in the sampled network traffic.

11. The device of claim 10, wherein the ML algorithm is trained for input reconstruction, and wherein the ML algorithm outputs higher normalized loss for anomaly input.

12. The device of claim 10, wherein the ML algorithm comprises at least one of: an auto-decoder deep learning network architecture and a generative adversarial network (GAN) architecture.

13. The device of claim 10, wherein the processor is further configured to classify a type of the identified anomaly.

14. The device of claim 13, wherein the processor is further configured to train another ML algorithm to classify the identified anomaly of the input vector based on a set of classes in the training dataset.

15. The device of claim 14, wherein the ML algorithm comprises at least one of: support vector ML architecture and deep learning network architecture.

16. The device of claim 13, wherein the processor is further configured to train the ML algorithm with a dataset of descriptive features that characterize the threat type based on the identified anomaly.

17. The device of claim 10, wherein the sampled network traffic comprises vectors in a plurality of time intervals.

18. The device of claim 10, wherein the ML algorithm is configured to allow a model trained in one installation to serve as a base model in another installation by normalizing the loss vectors of each installation.

19. The device of claim 10, wherein the memory is configured to store a trained model based on the training dataset.

20. A method of detecting threats in a computer network, the method comprising:
applying, by a processor, a machine learning (ML) algorithm on a sample of traffic captured from a computer network;
normalizing, by the processor, a loss determined by the ML algorithm, wherein the ML algorithm is trained with a training dataset to determine loss for traffic samples; and
analyzing, by the processor, the normalized loss to identify an anomaly based on at least one communication pattern in the captured traffic.
